(19) United States
(12) Patent Application Publication
(10) Pub. No.: US 2023/0386253 A1
(43) Pub. Date: Nov. 30, 2023

(54) IMAGE PROCESSING DEVICE, IMAGE PROCESSING METHOD, AND PROGRAM

(71) Applicant: NEC Corporation, Minato-ku, Tokyo (JP)

(72) Inventor: Kazuyuki SASAKI, Minato-ku, Tokyo (JP)

(73) Assignee: NEC Corporation, Minato-ku, Tokyo (JP)

(21) Appl. No.: 18/029,796

(22) PCT Filed: Oct. 8, 2020
(86) PCT No.: PCT/JP2020/038142

§ 371 Date: Mar. 31, 2023

(51) Int. Cl. G06V 40/16; G06T 7/20; G06T 7/70; G06V 10/74

(52) U.S. Cl. CPC G06V 40/172; G06T 7/20; G06T 7/70; G06V 10/761; G06V 40/161; G06T 2207/30201

(57) ABSTRACT

A face region of a person appearing in an image is detected, a body region of the person appearing in the image is detected; face collation processing is performed using image information of the face region, a correspondence relationship between the image information of the face region and the image information of the body region is identified when the image information of the face region and the image information of the body region satisfy a predetermined correspondence relationship, and the image information of the body region is recorded when the image information of the body region of the person identified as a result of the face collation processing satisfies a recording condition.

### TECHNICAL FIELD

The present disclosure relates to an image processing device, an image processing method, and a program.

### BACKGROUND ART

When performing person authentication, authentication processing is often performed using facial feature information. Patent Document 1 discloses a technique of authentication processing.

### PRIOR ART DOCUMENTS

### Patent Documents

Patent Document 1: PCT International Publication No. WO 2020/136795

### SUMMARY OF THE INVENTION

### Problems to be Solved by the Invention

When facial feature information cannot be acquired from an image, authentication using information such as other body features and clothing is under consideration. Here, even when facial features cannot be recognized, it is desired to authenticate a person multiple times with high accuracy over an extended period.

Accordingly, an object of the present invention is to provide an image processing device, an image processing method, and a program that solve the above-described problem.

### Means for Solving the Problem

According to the first example aspect of the present disclosure, an image processing device includes: a face detection means that detects a face region of a person appearing in an image; a body detection means that detects a body region of the person appearing in the image; a face collation means that performs face collation processing using image information of the face region; a correspondence relationship identification means that identifies a correspondence relationship between the image information of the face region and image information of the body region when the image information of the face region and the image information of the body region satisfy a predetermined correspondence relationship; and an image recording means that records the image information of the body region of the person identified as a result of the face collation processing, and the image recording means records the image information of the body region when the image information of the body region satisfies a recording condition.

According to a second example aspect of the present disclosure, an image processing method includes: detecting a face region of a person appearing in an image; detecting a body region of the person appearing in the image; performing face collation processing using image information of the face region; identifying a correspondence relationship between the image information of the face region and image information of the body region when the image information of the face region and the image information of the body region satisfy a predetermined correspondence relationship; and recording the image information of the body region when the image information of the body region of the person identified as a result of the face collation processing satisfies a recording condition.

According to a third example aspect of the present disclosure, a program causes a computer of an image processing device to function as: a face detection means that detects a face region of a person appearing in an image; a body detection means that detects a body region of the person appearing in the image; a face collation means that performs face collation processing using image information of the face region; a correspondence relationship identification means that identifies a correspondence relationship between the image information of the face region and image information of the body region when the image information of the face region and the image information of the body region satisfy a predetermined correspondence relationship; and an image recording means that records the image information of the body region when the image information of the body region of the person identified as a result of the face collation processing satisfies a recording condition.

### BRIEF DESCRIPTION OF THE DRAWINGS

FIG. 1 is a schematic configuration diagram of the collation system according to one example embodiment of this disclosure.

FIG. 2 is a diagram that shows the hardware constitution of the image processing device according to one example embodiment of this disclosure.

FIG. 3 is a function block diagram of the image processing device according to one example embodiment of this disclosure.

FIG. 4 is a first diagram showing the relationship between a facial image and a body image according to one example embodiment of this disclosure.

FIG. 5 is a second diagram showing the relationship between a facial image and a body image according to one example embodiment of this disclosure.

FIG. 6 is a third diagram showing the relationship between a facial image and a body image according to one example embodiment of this disclosure.

FIG. 7 is a fourth diagram showing the relationship between a facial image and a body image according to one example embodiment of this disclosure.

FIG. 8 is a diagram that shows a first processing flow of the image processing device according to the first example embodiment of this disclosure.

FIG. 9 is a diagram that shows a second processing flow of the image processing device according to the first example embodiment of this disclosure.

FIG. 10 is a functional block diagram of the image processing device according to the second example embodiment of this disclosure.

FIG. 11 is a functional block diagram of the image processing device according to the third example embodiment of this disclosure.

FIG. 12 is a diagram showing the processing flow according to the fourth example embodiment of this disclosure.

FIG. 13 is a diagram showing the processing flow according to the fifth example embodiment of this disclosure.

FIG. 14 is a diagram showing a minimum configuration of an image processing device.

FIG. 15 is a diagram showing the processing flow by an image processing device with a minimum configuration.

### EXAMPLE EMBODIMENT

An image processing device according to an example embodiment of the present disclosure will be described below with reference to the drawings.

FIG. 1 is a schematic configuration diagram of the collation system according to the present example embodiment.

A collation system 100 includes, as an example, an image processing device 1, a camera 2, and a display device 3. The collation system 100 is only required to include at least the image processing device 1. In the present example embodiment, the image processing device 1 is connected to a plurality of cameras 2 and a display device 3 via a communication network. For convenience of explanation, only one camera 2 is shown in FIG. 1. The image processing device 1 acquires a captured image of a person to be processed from the camera 2. As an example, the image processing device 1 uses a captured image of a person acquired from the camera 2 to perform person collation processing, tracking processing, and the like.

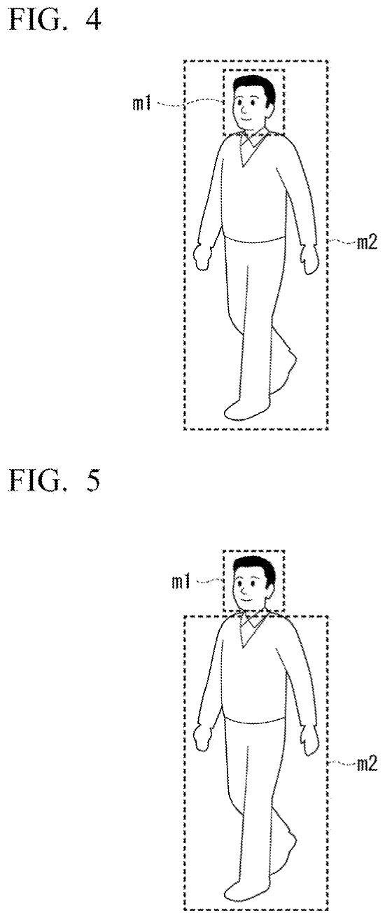

Note that the collation processing performed by the image processing device 1 refers to, as an example, processing that identifies, from a plurality of facial or body images stored in the image processing device 1, a facial image or a body image of a person appearing in a captured image acquired from the camera 2, using a facial image including a face region or a body image including a body region of a plurality of persons stored in the image processing unit 1 and a captured image including the face region or body region acquired from the camera 2. Details of a facial image and a body image will be described below with reference to FIGS. 4 to 7.

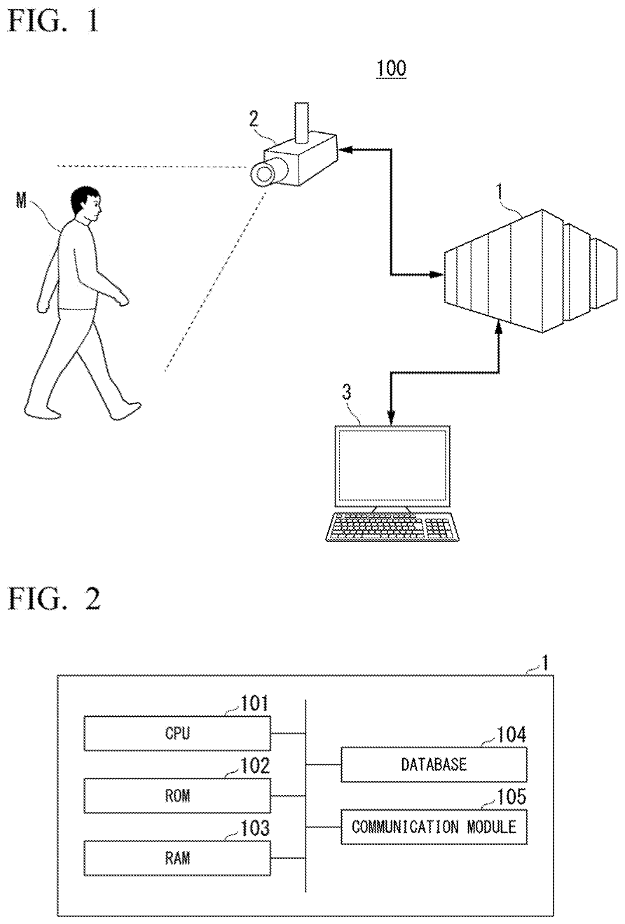

FIG. 2 is a diagram that shows the hardware constitution of the image processing device.

As shown in FIG. 2, the image processing device 1 is a computer including hardware such as a CPU (Central Processing Unit) 101, a ROM (Read Only Memory) 102, a RAM (Random Access Memory) 103, a database 104, a communication module 105, and the like. The display device 3 is also a computer having a similar hardware configuration.

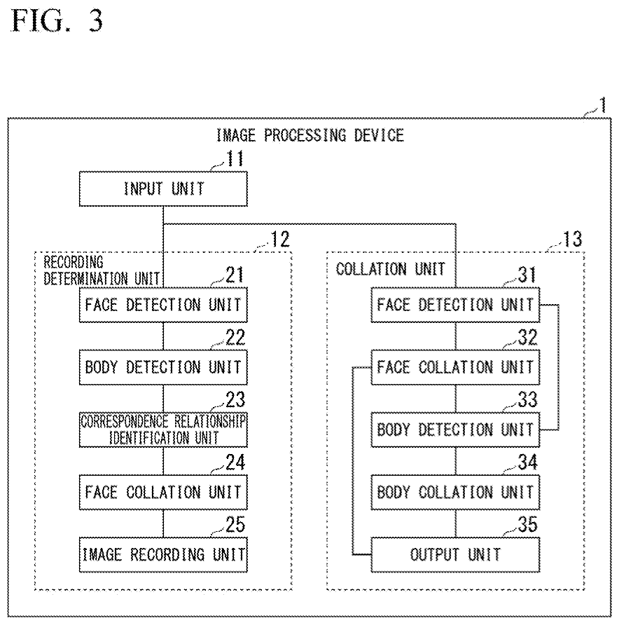

FIG. 3 is a functional block diagram of the image processing device.

In the image processing device 1, the CPU 101 executes an image processing program stored in the ROM 102 or the like. As a result, the image processing device 1 exhibits the functions of an input unit 11, a recording determination unit 12, and a collation unit 13.

The input unit 11 acquires a facial image from the camera 2.

The recording determination unit 12 determines whether to record a facial image or a recorded image.

The collation unit 13 performs collation processing.

The recording determination unit 12 exhibits the functions of a face detection unit 21, a body detection unit 22, a correspondence relationship identification unit 23, a face collation unit 24 and an image recording unit 25.

The face detection unit 21 detects a face region appearing in the captured image acquired from the camera 2.

The body detection unit 22 detects a body region appearing in the captured image acquired from the camera 2.

The correspondence relationship identification unit 23 identifies the correspondence relationship between the face image indicating a face region detected by the face detection unit 21 and the body image indicating a body region detected by the body detection unit 22.

The face collation unit 24 performs face collation processing using image information of the face region.

When the face matching process succeeds and a person can be identified, the image recording unit 25 records the body image as the information of the person. When a person can be identified, the image recording unit 25 may further record the face image as information of the person.

The collation unit 13 performs face collation processing or body collation processing using the face image or body image recorded by the recording determination unit 12. The collation unit 13 exhibits the functions of a face detection unit 31, a face collation unit 32, a body detection unit 33, a body collation unit 34, and an output unit 35.

The face detection unit 31 detects a face region appearing in a captured image acquired from the camera 2.

The face collation unit 32 performs face collation processing using image information of the face region. The face collation processing uses a face collation program.

The body detection unit 33 detects a body region appearing in the captured image acquired from the camera 2.

The body collation unit 34 performs body collation processing using the image information of the body region. The body collation processing uses a body collation program.

The output unit 35 outputs the processing result of the body collation unit 34 or the face collation unit 32.

In addition, the face collation program is a program that learns multiple face images and training data corresponding to the face images using machine learning processing such as a neural network, and calculates at least the degree of matching between an input face image and a face image that is a comparison target. More specifically, as an example, the image processing system 1 takes as input information a face image including the entire face, and as output information the degree of agreement indicating the likelihood of a correct answer for a plurality of comparison-target face images that are recorded in a database (that is, of being the face image of the same person as the face image of the input information), and learns their input-output relationship using machine learning processes such as neural networks to generate a face collation model. The image processing device 1 generates a face collation program including a face collation model, a neural network structuring program, and the like. The image processing device 1 may use a known technique to generate a face collation model that takes a face image including the entire face as input information and calculates the degree of agreement for a plurality of comparison-target face images recorded in a database.

In addition, the body collation program is a program that learns multiple body images and training data corresponding to the body images using machine learning processing such as a neural network, and calculates at least the matching degree between an input body image and a body image that is a comparison target. More specifically, as an example, the image processing system 1 takes as input information a body image, and as output information the degree of agreement indicating the likelihood of a correct answer for a plurality of comparison-target body images that are recorded in a database (that is, of being the body image of the same person as the body image of the input information), and learns their input-output relationship using machine learning processes such as neural networks to generate a body collation model. The image processing device 1 generates a body collation program including a body collation model, a neural network structuring program, and the like. The image processing device 1 may use a known technique to generate a body collation model that takes a body image as input information and calculates the degree of agreement for a plurality of comparison-target body images recorded in a database.

The collation system 100 of the present disclosure is, for example, an information processing system used to collate a person who enters a predetermined area multiple times within the predetermined area. For example, if the predetermined area is a theme park, collation processing is performed multiple times when a person enters the theme park or at predetermined locations in the theme park (for example, the entrance to an attraction or the entrance of a store). Alternatively, the predetermined area may be a predetermined region (country, prefecture, or region), public facility, building, office, or the like. In this case, the collation system 100 is an information processing system that is used to collate a person multiple times within a predetermined region (country, prefecture, or region), public facility, building, office, or other predetermined area.

FIG. 4 is a first diagram showing the relationship between a face image and a body image.

As shown in FIG. 4, the face image m1 may be an image region that includes the face region and does not include the body region. Also, as shown in FIG. 4, the body image m2 may be an image region including the entire face, arms, legs, body, and the like from head to toe.

FIG. 5 is a second diagram showing the relationship between a face image and a body image.

As shown in FIG. 5, the face image m1 may be an image region that includes the face region and does not include the body region. Also, as shown in FIG. 5, the body image m2 may be an image region that does not include the face region but includes the entire arms, legs, body, and the like from the neck to the toes.

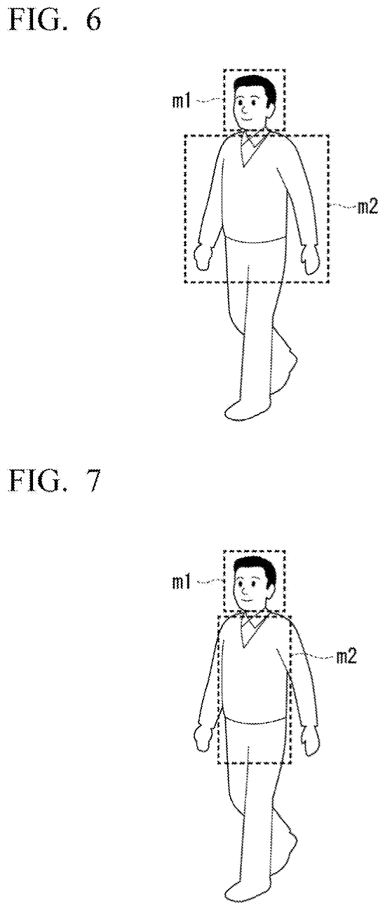

FIG. 6 is a third diagram showing the relationship between a face image and a body image.

As shown in FIG. 6, the face image m1 may be an image region that includes the face region and does not include the body region. Also, as shown in FIG. 6, the body image m2 may be an image region that does not include the face region, but includes the arms, torso, and the like from the neck to the waist and the vicinity of the crotch.

FIG. 7 is a fourth diagram showing the relationship between a face image and a body image.

As shown in FIG. 7, the face image m1 may be an image region that includes the face region and does not include the body region. Also, as shown in FIG. 7, the body image m2 may be an image region that does not include the face region and does not include the legs from the neck of the torso to the vicinity of the waist and crotch.

As shown in FIGS. 4 to 7, the region of the body included in the body image may be determined as appropriate. Also, the region included in the body image may be only the information about the clothes of the upper body. Also, the region included in the face image or the body image may be an image including only a region of the face or a region of the body of a person, with the background cut off.

### First Example Embodiment

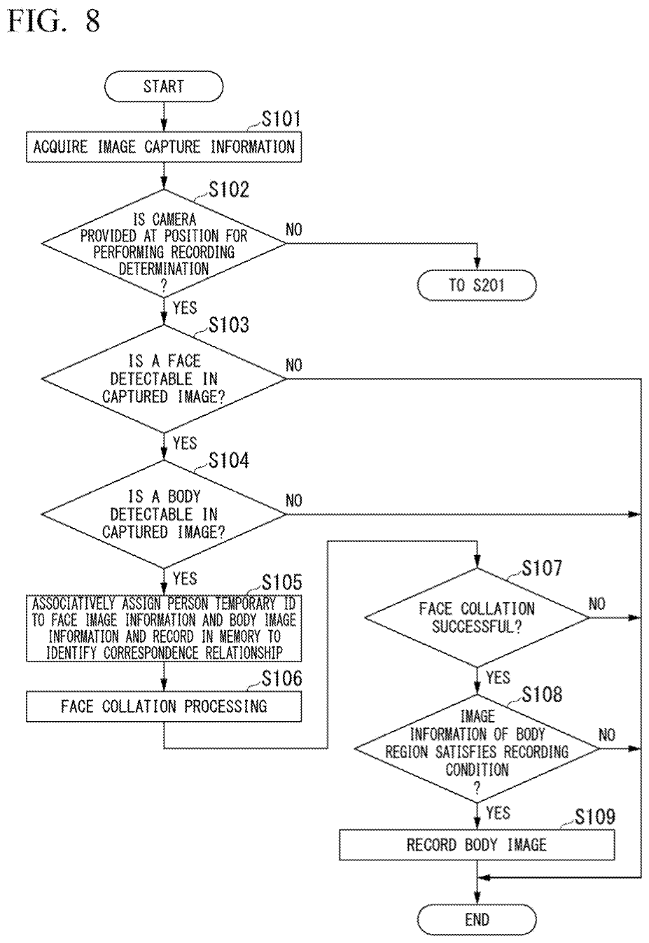

FIG. 8 is a diagram that shows a first processing flow of the image processing device according to the first example embodiment.

The first processing flow shows an example in which a person enters a predetermined area.

When a person M enters a predetermined area or passes a predetermined position, the camera 2 provided at a person image capture position such as an entry position or a passing position captures an image of the person M. The camera 2 transmits image capture information including the captured image of the person M and the ID of the camera 2 to the image processing device 1. The input unit 11 of the image processing device 1 acquires the image capture information from the camera 2 (Step S101). The input unit 11 of the image processing device 1 acquires the ID of the camera 2 included in the image capture information. Based on the ID of the camera 2, the input unit 11 determines whether or not the camera 2 is a camera installed at a position, such as an entrance position or a predetermined person image capture position, for performing a recording determination of a person who appears in the captured image (Step S102). The input unit 11 reads the camera type corresponding to the ID of the camera 2 on the basis of the record of a camera type table of the database 104, which stores the correspondence between the ID of the camera 2 and the information indicating the camera type. The input unit 11 outputs the image capture information to the recording determination unit 12 when the camera type indicates a type to which recording determination is performed. The input unit 11 outputs the image capture information to the collation unit 13 when the camera type does not indicate being a type to which a recording determination is performed.

The recording determination unit 12 acquires image capture information from the input unit 11. In the recording determination unit 12, the face detection unit 21 reads the captured image from the image capture information. The face detection unit 21 determines whether a face can be detected in the captured image (Step S103). A known technique may be used to detect the face in the captured image. For example, face detection may be performed using the reliability of facial feature points included in the captured image, which is calculated using a known technique. The detection of the face may be performed based on information obtained as a result of inputting a captured image to a face detection model generated by machine learning. For example, the face detection model may be a model generated by performing, on a large number of captured images, machine learning processing of the input/output relationship, in which the input information is a captured image that includes a face in a region, and the output information is the region of the face, feature points, and reliability values thereof. When the face detection unit 21 can detect a face in the captured image, the face detection unit 21 outputs the captured image ID indicating the captured image to the body detection unit 22. In addition, the face detection unit 21 records coordinate information (face image information) of the four corners of the rectangular face image m1 including the detected face region in the memory in association with the captured image ID.

The body detection unit 22 determines whether a body can be detected in the captured image indicated by the acquired captured image ID (Step S104). A known technique may be used to detect a body in the captured image. For example, body detection may be performed by extracting a feature such as the skeleton of a body appearing in the image and detecting the body based on that feature. The detection of the face may be performed on the basis of information obtained as a result of inputting a captured image to a body detection model generated by machine learning. For example, the body detection model may be a model generated by performing, on a large number of captured images, machine learning processing of the input/output relationship, in which the input information is a captured image that includes a body in a region, and the output information is the region of the body, feature points of the skeleton, and reliability values thereof. When the body detection unit 22 can detect a body in the captured image, the body detection unit 22 outputs the captured image ID indicating the captured image to the correspondence relationship identification unit 23. In addition, as an example, the body detection unit 22 records coordinate information (body image information) of the four corners of the rectangular body image m2 including the detected body region in the memory in association with the captured image ID.

Upon acquiring the captured image ID from the body detection unit 22, the correspondence relationship identification unit 23 assigns a person temporary ID in association with the face image information and body image information recorded in the memory in association with that captured image ID, and records it in memory to identify the correspondence relationship (Step S105). As a result, the captured image ID, the temporary person ID, the face image information (coordinate information), and the body image information (coordinate information) are recorded in the memory in association with each other, and the face region and the body region in the captured image of the person M are recorded correspondingly. The correspondence relationship identification unit 23 further records the face image m1 identified from the face image information in the captured image in the memory in association with the captured image ID and the temporary person ID. Also, the correspondence relationship identification unit 23 further records the body image m2 identified from the body image information in the captured image in the memory in association with the captured image ID and the temporary person ID.

When identifying the correspondence relationship between the face image information and the body image information, the correspondence relationship identification unit 23 may determine the correspondence relationship based on the coordinate information of the face image information and the body image information. For example, based on the distance between the lower left and lower right coordinates of the face image information and the upper left and upper right coordinates of the body image information, the correspondence relationship identification unit 23 may determine whether each of the left and right coordinates is within a predetermined distance, and determine that there is a correspondence relationship between the face image information and the body image information (image information of the same person) if equal to or less than the predetermined distance.

Alternatively, the correspondence relationship identification unit 23 may input the captured image in which the face is detected by the face detection unit 21 and the body is detected by the body detection unit 22 to a correspondence relationship identification model, and on the basis of the result output by the correspondence relationship identification model, may obtain a result that the face region and the body region are regions of the same person, and identify the relationship between the face region and the body region based on the result. In this case, the correspondence relationship identifying unit 23 may acquire the face image information (coordinates) indicating the face region and the body image information (coordinates) indicating the body region output by the correspondence relationship identification model, and replace image information that is recorded in the memory in association with the captured image ID or temporary person ID with them. For example, the correspondence relationship identification model may be a model that is generated by performing, for a large number of captured images, machine learning of an input/output relationship in which a captured image including a face and a body in a region serves as the input information, and the face region and the body region of one person in the captured image serve as the output information.

Even when a plurality of persons appear in the captured image, the correspondence relationship identification unit 23 can identify the correspondence relationship between the face region and the body region of each person. For example, the correspondence relationship identification unit 23 inputs to the correspondence relationship identification model the captured image in which the face detection unit 21 has detected the faces of a plurality of persons and the body detection unit 22 has detected the bodies of the plurality of persons. Then, the body detection unit 22 may acquire the result that the face region and the body region are regions of the same person region for each person based on the result output by the correspondence relationship identification model, and based on that result, identify the relationship between the face region and the body region of each person. The correspondence relationship identification model may be a model that is generated by performing, for a large number of captured images, machine learning of an input/output relationship in which a captured image that includes the faces and bodies of multiple persons in a region serves as the input information, and information in which the correspondence relationship between the face region and body region of each person appearing in the captured image serves as the output information.

Upon recording information such as face image information (coordinates), body image information (coordinates), face image m1, and body image m2 of a person in a captured image in the memory in association with the captured image ID and the temporary person ID, the correspondence relationship identification unit 23 determines that the correspondence relationship can be identified, and outputs the captured image ID and the temporary person ID to the face collation unit 24. The face collation unit 24 acquires the captured image ID of the captured image containing the person whose correspondence relationship has been identified, and the person temporary ID detected for that captured image.

The face collation unit 24 reads the face image recorded in the memory in association with the captured image ID and the temporary person ID. The face collation unit 24 performs face collation processing for that face image using a face collation program (Step S106). The face collation unit 24 inputs a comparison-target face image identified in order from the plurality of face images contained in the database 104. The comparison-target face image may be a face image registered in the database 104 in advance.

The face collation unit 24 calculates the degree of matching between the face image detected by the face detection unit 21 and the face image specified from among the plurality of face images (comparison targets) included in the database 104, for each face image specified in order from among the plurality of face images contained in the database 104. As described above, the face collation program is a program using a model generated by machine learning processing. Thereby, the face collation unit 24 can calculate the degree of matching between the face image detected by the face detection unit 21 and each specified face image from the database 104. The face collation unit 24 determines whether the highest degree of matching between the face image detected by the face detection unit 21 and each specified face image from the database 104 is equal to or greater than a predetermined threshold, and thereby determines whether or not the face collation has succeeded (Step S107). The face collation unit 24 determines that the face collation is successful when the highest degree of matching between the face image detected by the face detection unit 21 and each specified face image from the database 104 is equal to or greater than the predetermined threshold, and determines that the comparison-target face image matches the face image detected by the face detection unit 21.

The face collation unit 24 identifies from the database 104 the person information of the comparison-target face image that is determined to match in the database 104. The person information includes a person ID for identifying the person of the face image. Thereby, the face collation unit 24 can link the captured image ID, the temporary person ID, and the person ID. In other words, it is possible to link the temporary person ID assigned to the person appearing in the captured image indicated by the captured image ID with the person ID of the person indicated by the comparison-target face image that was collated with and matches that person. The face collation unit 24 outputs to the image recording unit 25 a collation result including the captured image ID, the temporary person ID, the person ID, and flag information indicating successful face collation.

The image recording unit 25 reads the body image recorded in the memory in association with the captured image ID, the temporary person ID, and the person ID. The image recording unit 25 determines whether the read body image and the image information of the body region included in that body image satisfy a recording condition (Step S108). The image recording unit 25 determines to record the body image when the body image or the image information of the body region satisfies the recording condition. The recording condition is, for example, information indicating a condition under which an image is required to be in a predetermined state. For example, as a recording condition, at least one of the brightness or saturation indicated by the body image is equal to or greater than a predetermined threshold, or a state in which it can be determined that there is no blur may be set as the predetermined condition. Also, the recording condition may be information indicating that the posture of the person whose body region is detected is in a predetermined state. For example, the recording condition is information indicating a condition such as that an arm is included in the body region, that a leg is included, and that the front can be assumed. A known technique may be used to determine whether these recording conditions are met. Alternatively, whether or not the recording condition is met may be determined using a recording condition determination model generated using a machine learning technique. The recording condition determination model is a learning model obtained by machine-learning an input-output relationship in which a body image is input information and a result indicating whether or not a predetermined recording condition is satisfied is output information. By recording a body image that satisfies a predetermined condition, it is possible to record only appropriate information as a body image to be used later for collation.

The image recording unit 25 reads the brightness or saturation of each pixel indicated by the body image, and by determining whether they are equal to or greater than a threshold value, determines whether the brightness or saturation indicated by the body image is equal to or greater than a predetermined threshold value. The image recording unit 25 may determine the edge of the contour of the body based on the pixels indicated by the body image, and determine whether there is blurring based on the presence or absence of the edge and the area. Known techniques may be used to determine whether the brightness and saturation of these images are equal to or greater than thresholds and whether there is blurring.

In addition, the image recording unit 25 may compare the shape of the person whose body region has been detected with the shape of the person who satisfies the pre-stored recording condition by pattern matching, and if they are matched using the pattern matching, may determine that the posture of the person whose body region has been detected is in a predetermined state. Alternatively, the image recording unit 25 may calculate the orientation of the frontal direction of the person based on the shape of the person whose body region has been detected, and when an angle at which it can be determined that the person is facing the direction of the camera 2 on the basis of the angle formed by that orientation vector and the direction vector of the shooting direction of the camera 2, may determine that the posture of the person whose body region is detected is in a predetermined state.

Based on the shape of the person whose body region has been detected, the image recording unit 25 may also determine whether both arms and both legs appear, and when they appear, may determine that the posture of the person whose body region has been detected is in a predetermined state.

When the body image or the image information of the body region included in the body image satisfies the recording condition, the image recording unit 25 records the body image in the database 104 in association with the person ID and flag information indicating success of face collation (Step S109). The image recording unit 25 may read a face image recorded in the memory in association with the captured image ID, temporary person ID and person ID, and record the face image in the person table of the database 104 in association with the person ID and flag information indicating successful face collation. The image recording unit 25 may read a body image and a face image recorded in the memory in association with the captured image ID, temporary person ID and person ID, and record the body image and face image in the person table of the database 104 in association with the person ID and flag information indicating successful face collation. The image recording unit 25 may read a body image and a face image recorded in the memory in association with the captured image ID, temporary person ID and person ID, and the captured image in which the body image and face image appear, and record the body image, face image and captured image in the person table of the database 104 in association with the person ID and flag information indicating successful face collation. The face image and captured image may also be recorded when a predetermined recording condition is satisfied, as with the body image. The image processing device 1 uses the body image and the face image recorded in the person table for the person collation process to be performed later. Since the body image, the face image, and the captured image that satisfy the predetermined recording condition are recorded in this manner, the collation process can be performed with higher accuracy.

The recording determination unit 12 repeats the above-described processing of steps S101 to S109 each time a captured image is input. As a result, when the camera 2 that generated the captured image is a camera installed at a position for performing a recording determination of a person appearing in the captured image, such as an entrance position or a predetermined person image capture position, the body image and face image of the person who appears in the captured image are recorded in the person table.

Originally, the face image and body image of the person to be registered are registered in the person table. However, by the processing of the recording determination unit 12, the face image and body image of the person to be registered who is registered in advance in the person table are additionally recorded. Alternatively, the recording determination unit 12 may repeatedly update the face image and body image of the person to be registered, which is registered in advance in the person table, by replacing it with the face image and body image generated from the newly acquired captured image. If the camera 2 installed at a position for performing recording determination of a person appearing in a captured image, such as an entry position or a predetermined person image capture position is provided in a plurality in a predetermined area such as a theme park, a predetermined region (country, prefecture, or region), a public facility, a building, etc., when captured by those cameras 2, the face image and body image of the person M are automatically recorded and stored or updated in the person table. Therefore, for example, even if the person M changes clothes within the predetermined area, the body image of the person M in the state of wearing the clothes after changing can be recorded. Also, even if the person M wears glasses or sunglasses or wears a mask within the predetermined area, the face image may be accumulated. The face collation process described above may be performed using partial face information.

Then, when the person M is photographed by the camera 2 of a camera type indicating that the camera type is a type to which collation processing is performed, the image processing unit 1 performs the collation processing by comparing the face image or body image of the person M contained in the captured image acquired from camera 2 of the type to which the collation processing is performed with the face image m1 or body image m2 of the person M contained in the captured image acquired from the camera 2 of the camera type that indicates, through the above process, that it is the type to which a recording determination is performed.

Note that the camera 2 installed in the predetermined area in the present disclosure may be a camera to which a type ID indicating both the type to which a recording determination is performed and the type to which collation processing is performed is assigned. In this case, the image processing device 1 can perform both the recording determination process described above and the collation process described below for the captured image acquired from the camera 2.

The processing described above with reference to FIG. 8 is executed in parallel for each frame of a plurality of captured images generated by image capture control of a plurality of cameras 2.

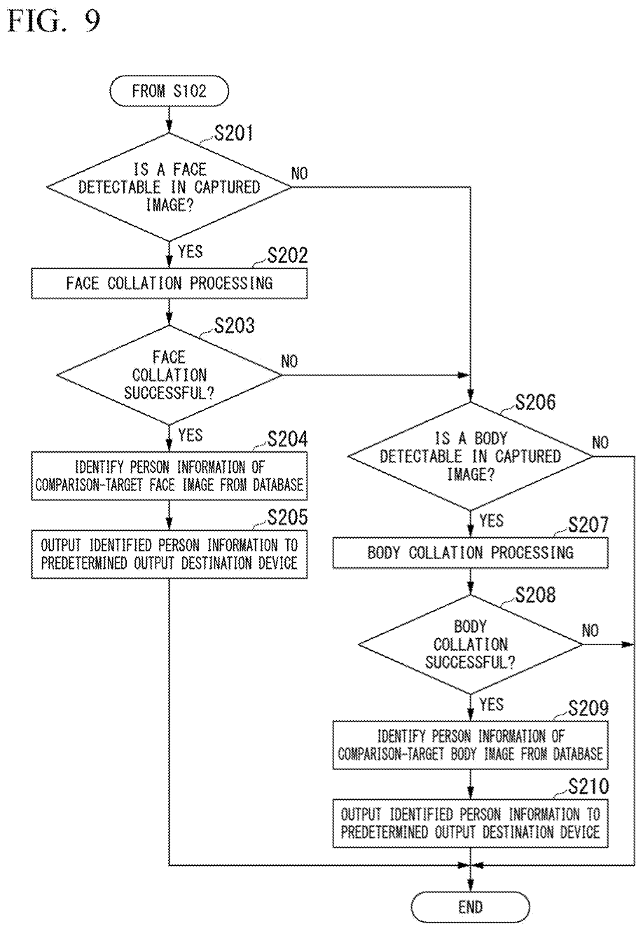

FIG. 9 is a diagram showing a second processing flow of the image processing device.

Next, a second processing flow of the image processing device 1 will be described. The second processing flow is the processing flow of collation processing. It is assumed that the camera 2 is provided at an image capture position for performing collation processing. The camera 2 captures an image of the person M. The camera 2 transmits image capture information including the captured image of the person M and the ID of the camera 2 to the image processing device 1. The input unit 11 of the image processing device 1 acquires the image capture information from the camera 2 (Step S101 in FIG. 8). The input unit 11 of the image processing device 1 acquires the ID of the camera 2 included in the image capture information. On the basis of the ID of the camera 2, the input unit 11 determines whether the camera 2 is a camera provided at a position for performing recording determination such as an entry position (Step S102 in FIG. 8). If the result of this determination is No, the camera 2 is a camera provided at an image capture position for performing collation processing. The input unit 11 reads the camera type corresponding to the ID of the camera 2 on the basis of the record of a camera type table of the database 104, which stores the correspondence between the ID of the camera 2 and the information indicating the camera type. When the input unit 11 indicates that the camera type is not the type to which recording determination is performed, the input unit 11 outputs the image capture information to the collation unit 13 because the camera is provided at an image capture position for performing collation processing. The processing up to the above is the same as the first processing flow described above.

The face detection unit 31 of the collation unit 13 acquires the image capture information from the input unit 11. The face detection unit 31 determines whether a face can be detected in the captured image (Step S201). A known technique may be used to detect the face in the captured image. For example, face detection may be performed using the reliability of facial feature points included in the captured image, which is calculated using a known technique. The detection of the face may be performed based on information obtained as a result of inputting a captured image to a face detection model generated by machine learning. For example, the face detection model may be a model generated by performing, on a large number of captured images, machine learning processing of the input/output relationship, in which the input information is a captured image that includes a face in a region, and the output information is the region of the face, feature points, and reliability values thereof. Upon detecting a face in the captured image, the face detection unit 21 instructs the face collation unit 32 to perform face collation. When the face detection unit 21 cannot detect a face in the captured image, it instructs the body detection unit 33 to detect a body.

The face collation unit 32 performs face collation processing on the basis of the face region detected in the captured image (Step S202). The face collation unit 32 inputs a comparison-target face image identified in order from the plurality of face images contained in the database 104.

The face collation unit 32 calculates the degree of matching between the face image detected by the face detection unit 31 and the face image specified from among the plurality of face images (comparison targets) included in the database 104, for each face image specified in order from among the plurality of face images contained in the database 104. As described above, the face collation program is a program using a model generated by machine learning processing. Thereby, the face collation unit 32 can calculate the degree of matching between the face image detected by the face detection unit 31 and each specified face image from the database 104. The face collation unit 32 determines whether the highest degree of matching between the face image detected by the face detection unit 31 and each specified face image from the database 104 is equal to or greater than a predetermined threshold, and thereby determines whether or not the face collation has succeeded (Step S203). Upon determining that the highest degree of matching between the face image detected by the face detection unit 31 and each specified face image from the database 104 is equal to or greater than the predetermined threshold, the face collation unit 32 determines that the comparison-target face image matches the face image detected by the face detection unit 31 and determines that the face collation is successful. Upon determining that the highest degree of matching between the detected by the face detection unit 31 and each specified face image from the database 104 is not equal to or greater than the predetermined threshold, the face collation unit 32 determines that the face collation processing is unsuccessful and instructs the body detection unit 33 to detect a body.

The face collation unit 32 identifies from the database 104 the person information of the comparison-target face image that is determined to match in the database 104 (Step 204). The person information includes a person ID for identifying the person of the face image. The face collation unit 32 outputs the person information to the output unit 35. The output unit 35 outputs the person information identified by the face collation unit 32 based on the captured image to a predetermined output destination device (Step S205).

As a result, the image processing device 1 can perform predetermined processing using the result of the collation processing of the person M appearing in the captured image. For example, when the collation system 100 of the present disclosure is used in a theme park, which is a predetermined area, it may be a device that determines whether or not entry is possible to an attraction in the theme park using person information. For example, if the person information includes a type indicating the attraction that the person is going to enter, the output destination device may determine that the person can enter the attraction. Alternatively, when the collation system 100 of the present disclosure is used in an office, which is a predetermined area, the output destination device may perform control to enable operation of a computer installed in the office using person information. For example, if the person information includes an identifier of an operable computer, the output destination device may perform control to enable operation of the computer corresponding to the identifier.

In Step S201, when a face cannot be detected, the body detection unit 33 acquires a body detection instruction from the face detection unit 31. Alternatively, if face collation cannot be performed in Step S203, the body detection unit 33 acquires a body detection instruction from the face collation unit 32. The body detection unit 33 determines whether a body can be detected in the captured image (Step S206). A known technique may be used to detect a body in the captured image. For example, body detection may be performed using the reliability of feature points of the skeleton of the body included in the captured image, which is calculated using a known technique. The detection of the body may be performed on the basis of information obtained as a result of inputting a captured image to a body detection model generated by machine learning. For example, the body detection model may be a model generated by performing, on a large number of captured images, machine learning processing of the input/output relationship, in which the input information is a captured image that includes a body in a region, and the output information is the region of the body, feature points, and reliability values thereof. Upon detecting a body in the captured image, the body detection unit 33 instructs the body collation unit 34 to perform body collation. When the body detection unit 33 cannot detect a body in the captured image, it makes a determination to end the processing.

Upon acquiring the body collation instruction, the body collation unit 34 performs body collation processing on the basis of the body region detected in the captured image (Step S207). The body collation unit 34 inputs a comparison-target face image m2 identified in order from the plurality of body images contained in the database 104.

The body collation unit 34 calculates the degree of matching between the body image detected by the body detection unit 33 and the body image specified from among the plurality of body images (comparison targets) included in the database 104, for each body image specified in order from among the plurality of body images contained in the database 104. As described above, the body collation program is a program using a model generated by machine learning processing. Thereby, the body collation unit 34 can calculate the degree of matching between the body image detected by the body detection unit 33 and each identified body image from the database 104. The body collation unit 34 determines whether the highest degree of matching between the body image detected by the body detection unit 33 and each body image specified from the database 104 is equal to or greater than a predetermined threshold, and whether the body image specified in the database 104 is recorded in association with flag information indicating successful face collation, and thereby determines whether or not body collation has been successful (Step S208). When the body collation unit 34 determines that the highest degree of matching between the body image detected by the body detection unit 33 and each body image specified from the database 104 is equal to or greater than a predetermined threshold, and that the comparison-target body image specified in the database 104 is recorded in association with flag information indicating successful face collation, the collation unit 34 determines that the comparison-target body image matches the body image detected by the body detection unit 33, and determines the body collation to be successful (Step S208). When the body collation unit 34 determines that the highest degree of matching between the body image detected by the body detection unit 33 and each body image specified from the database 104 is not equal to or greater than a predetermined threshold, or that the comparison-target body image specified in the database 104 is not recorded in association with flag information indicating successful face collation, the collation unit 34 determines the body collation processing to be unsuccessful and ends the processing. By not recording a body image that is not associated with flag information indicating successful face matching, it is possible to prevent recording of a body image in which only body collation is successful while collation of the face cannot be performed.

The body collation unit 34 specifies from the database 104 the person information of the comparison-target body image that is determined to match in the database 104 (Step 209). The person information includes a person ID for specifying the person of the body image. The body collation unit 34 outputs the person information to the output unit 35 (Step S210). The output unit 35 outputs the person information specified by the body collation unit 34 based on the captured image to a predetermined output destination device (Step S211). As a result, the image processing device 1 can perform predetermined processing using the result of the collation processing of the person M appearing in the captured image. For example, when the collation system 100 of the present disclosure is used in a theme park, which is a predetermined area, it may be a device that determines whether or not entry is possible to an attraction in the theme park using person information. For example, if the person information includes the type of attraction that the person can use, the output destination device may determine that the person can use the attraction.

Even when the face detection unit 31 cannot detect a face or when face collation is unsuccessful in the face collation unit 32, when the collation processing is successful as a result of the body collation processing by the body collation unit 34, the image processing device 1 can perform control so that predetermined processing is performed in the output destination device. Alternatively, even when the face detection unit 31 cannot detect a face or when face collation is unsuccessful in the face collation unit 32, the image processing device 1 itself may use the results of the body collation processing by the body collation unit 34 to perform some processing.

The processing described above with reference to FIG. 9 is also executed in parallel for each frame of a plurality of captured images generated by image capture control of a plurality of cameras 2.

In the above-described example embodiment, the camera 2 provided at a position such as an entry position or a predetermined person image capture position for performing a recording determination of a person appearing in a captured image may be installed at each position respectively capturing an image of a person at a predetermined fixed point from multiple directions. Accordingly, by recording face images and body images of a person captured from a plurality of directions and using such recorded images as comparison objects, it is possible to collate the person with higher accuracy.

### Second Example Embodiment

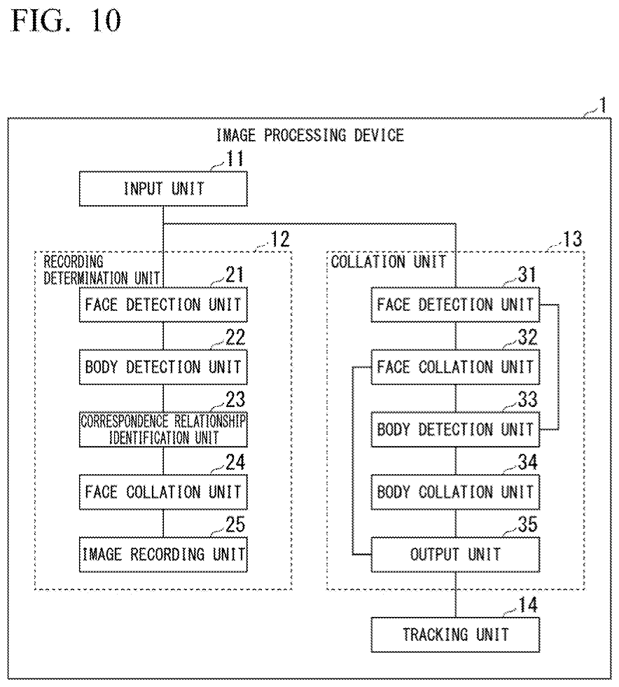

FIG. 10 is a functional block diagram of the image processing device according to the second example embodiment.

The image processing device 1 further includes a tracking unit 14 as shown in FIG. 10. The image processing device 1 may be a device that tracks the person M based on the output result of the output unit 35. For example, even if the face detection unit 31 cannot detect a face, or if face collation is unsuccessful in the face collation unit 32, when the body collation unit 34 performs the body matching process and the collation process succeeds, the output unit 35 outputs the person information specified by the body matching process, the captured image, the identification information of the camera 2 that acquired the captured image, the installation coordinates of the camera 2, and the detection time to the tracking unit 14. The tracking unit 14 associates those pieces of information and records them in a tracking table. The collation unit 13 and the tracking unit 14 repeat similar processing. As a result, the person information about the person M, the captured image, the identification information of the camera 2 that acquired the captured image, the installation coordinates of the camera 2, and the detection time are sequentially accumulated in the tracking table. As a result, the image processing device 1 can track the movement of the person M later based on the history recorded in the tracking table. The tracking unit 14 may use the face image of the person M to perform the tracking processing.

### Third Example Embodiment

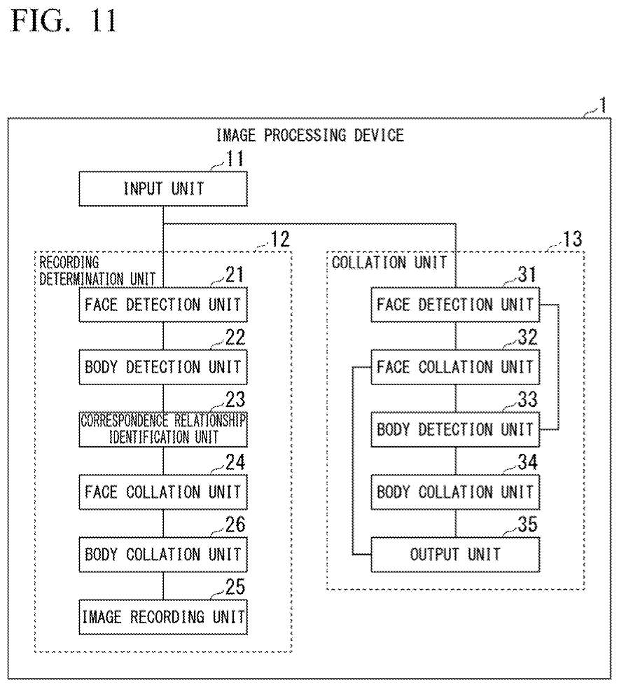

FIG. 11 is a functional block diagram of the image processing device according to the third example embodiment.

In the process of the recording determination unit 12 in the first example embodiment, only when the face collation process is successful, the person ID indicating the person specified by the face collation processing is recorded in the person table in association with the body image, the face image, and the captured image. However, by performing not only the face collation processing but also the body detection processing and the body collation processing, when it is determined that there is a match with the same person on the basis of the results of the face collation processing and the body collation processing, the person ID may be recorded in the person table in association with the body image, the face image, and the captured image. In this case, the recording determination unit 12 further includes a body collation unit 26.

In this case, after the body detection is performed by the body detection unit 22, the body collation unit 26 performs body collation processing using previously recorded image information of the body region of the person identified as a result of the face collation process and image information of the body region having a correspondence relationship with the image information of the face region used in the face collation processing. The image recording unit 25 records image information including the body region of the person identified as a result of the face collation processing (body image) when the image information of the body region having a correspondence relationship with the image information of the face region used in the face collation processing is determined in the body collation processing to be image information of the body region of the person identified as a result of the face collation processing. The processing of the body detection unit 22 and the processing of the body collation unit 26 are the same as the processing of the body detection unit 33 and the processing of the body collation unit 34 described in the first example embodiment. With such processing, since the body image is recorded when both the face collation processing and the body collation processing are successful, it is possible to record the body image information of a specific person with higher accuracy.

### Fourth Example Embodiment

The recording condition described in the first example embodiment may be information indicating that attributes (e.g., color of clothing, shape of clothing, etc.) or accessories (e.g., glasses, hat, etc.) of the person whose body region has been detected differ from the image information of the body region recorded for the person identified as a result of the face collation processing. As a result, for example, when the clothing indicated by the body image recorded in advance in the person table differs from the clothing indicated by the body region of the captured image newly processed by the recording determination unit 12 in the recording determination processing, it is possible to newly record that body image assuming that the person M has changed clothes in a predetermined area.

According to the processing of the image processing device of each of the above-described example embodiments, even when facial features cannot be recognized, it is possible to record a body image for highly accurate authentication of a person multiple times over an extended period. By recording a body image, even if facial features cannot be recognized, a person can be authenticated multiple times over an extended period of time with high accuracy.

According to the collation system described above, if a plurality of camera 2 installed at a position for performing recording determination of a person appearing in a captured image, such as an entry position or a predetermined person image capture position, are provided in a predetermined area such as a theme park, a predetermined region (country, prefecture, or region), a public facility, a building, etc., the body image of each person is recorded. Even if the person changes clothes within the predetermined area, it is possible to perform collation and tracking of the person using only the body image of the person.

If the predetermined area is a theme park, the camera 2 that performs recording determination is installed at the entrance gate of the theme park or at a predetermined position in each area. Based on the images taken by the camera 2 that performs the recording determination, the best-shot body image of each person satisfying the recording condition is recorded in the collation system 100. During the use of attractions installed in each area, even if collation using a person's face image is not possible, the image processing device can collate a person using only a body image by the processing of the collation unit 13 described above. In a theme park, users may perform actions such as putting on hats, changing clothes, and wearing masks. Even in such cases, the user can be collated with a higher degree of accuracy. Similarly, when tracking a person in a predetermined area such as a theme park, the person can be tracked using only body images.

In the above processing, the image recording unit 25 may classify the body images that are determined to be recorded in the recording determination process by category, and register each body image. For example, the image recording unit 25 acquires the position coordinates of the camera 2 that generated the captured image. The image recording unit 25 compares the position coordinates of small areas which are demarcated in the predetermined area with the positional coordinates specified for the captured image including the body image to be recorded, and identifies the small area corresponding to the body image. Then, the image recording unit 25 may record the identification information of the small area and the body image determined to be recorded in the person table in association with each other. As a result, for example, body images used for collation processing can be recorded for different areas within a theme park. In the collation processing, the collation unit 13 identifies the location where the image of a person was captured based on the installation position of the camera 2, and identifies the body image recorded in association with the identification information of the small area corresponding to the position coordinates of the installation position. Then, the collation unit 13 performs collation processing using the identified body image as an image to be compared. As an example, it is conceivable that each area in a theme park has a different theme, and visitors change clothes or change decorations according to the theme. In addition, it is considered that visitors wear their normal attire when entering and exiting the area. Even in such a case, a body image may be registered in association with location information for each area, and the collation process may be performed using the body image registered within the area.

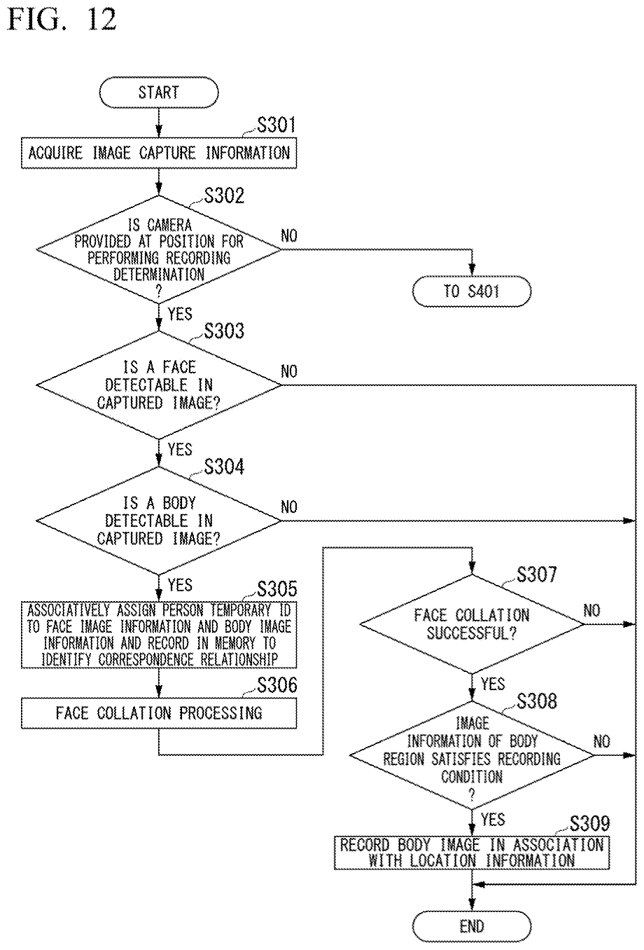

FIG. 12 is a diagram showing the processing flow according to the fourth example embodiment.

When the person M enters a predetermined area in a theme park, the camera 2 provided at the entry position takes a picture of the person M. The camera 2 transmits image capture information including the captured image of the person M and the ID of the camera 2 to the image processing device 1. The input unit 11 of the image processing device 1 acquires the image capture information from the camera 2 (Step S301). The subsequent steps S302 to S308 are the same as in the first example embodiment. When the body image or the image information of the body region included in the body image satisfies the recording condition, the image recording unit 25 records that body image in association with the person ID, flag information indicating successful face collation, and location information indicating the location where the captured image was taken in the person table of the database 104 (Step S309). The image recording unit 25 may read a face image recorded in the memory in association with the captured image ID, temporary person ID and person ID, and record the face image in the person table of the database 104 in association with the person ID, the flag information indicating successful face collation and location information.

Then, when actually performing collation processing of a person appearing in a captured image on the basis of image capture information including a captured image taken by the camera 2 installed at each position in the theme park, the image processing device 1 identifies the theme park based on the location information included in the image capture information of the camera 2. When performing the processing described with reference to FIG. 9, the image processing device 1 performs the same collation processing as the first example embodiment described using FIG. 9 by specifying a comparison object face image and body image from the database 104 associated with the location information indicating the area of the theme park, and comparing them with the face image and body image appearing in the captured image.

The image processing device 1 may perform re-registration of recorded body images and face images at a predetermined timing. For example, the image processing device 1 deletes the body image of each person from the person table at a predetermined time such as 00:00. Then, the image processing device 1 may newly perform the recording determination processing for each person and record new body images.

The image processing device 1 may create a list of person images for a predetermined period of time, including face images and body images, based on the correspondence relationship between the recorded body images and face images, and record the list for each person. Then, on the basis of a request from each person, data of the list of person images of the person may be transmitted to a terminal carried by the person. The image processing device 1 transmits the list of person images in an album format, whereby each person can check the images captured within a predetermined area.

The image processing device 1 may delete face images and body images recorded in the person table at a predetermined timing. For example, the image processing device 1 performs collation processing based on an image captured by the camera 2 installed near an exit of a predetermined area. The image processing device 1 may, for the person matched in the collation processing, delete all the image information such as the face images and the body images recorded in the person table.

### Fifth Example Embodiment

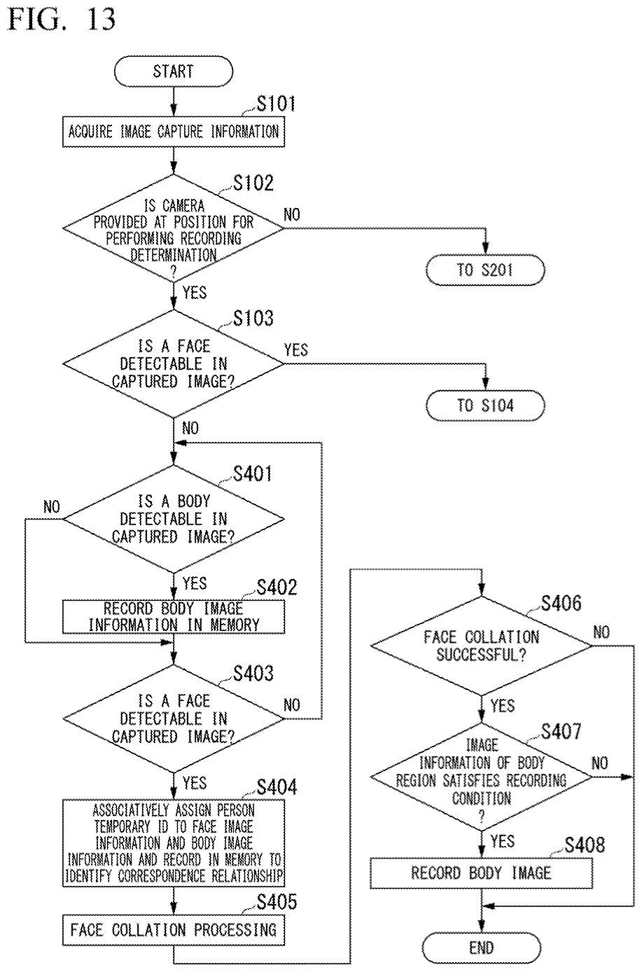

FIG. 13 is a diagram showing the processing flow according to the fifth example embodiment.

In the explanation of the processing for recording a body image using FIG. 8 in the first example embodiment, the processing for recording the body image when face collation is successful has been described. However, in other example embodiments, the following processing may be performed for the case in which a face image having a resolution for face collation cannot be obtained from a captured image obtained by photographing a person at a location with a long photographing distance.

Specifically, the input unit 11 of the image processing device 1 acquires the image capture information from the camera 2 (Step S101). The input unit 11 of the image processing device 1 acquires the ID of the camera 2 included in the image capture information. Based on the ID of the camera 2, the input unit 11 determines whether or not the camera 2 is located at a position, such as an entrance position or a predetermined person image capture position, for determining whether or not the person in the captured image is to be recorded (Step S102). The input unit 11 reads the camera type corresponding to the ID of the camera 2 on the basis of the record of a camera type table of the database 104, which stores the correspondence between the ID of the camera 2 and the information indicating the camera type. The input unit 11 outputs the image capture information to the recording determination unit 12 when the camera type indicates a type that performs a recording determination. The input unit 11 outputs the image capture information to the collation unit 13 when the camera type does not indicate being a type that performs a recording determination.

The recording determination unit 12 acquires image capture information from the input unit 11. In the recording determination unit 12, the face detection unit 21 reads the captured image from the image capture information. The face detection unit 21 determines whether a face can be detected in the captured image (Step S103). The processing up to this point is the same as in the first example embodiment.

When it is determined in Step S103 that a face cannot be detected (in the case of No), the body detection unit 33 determines whether a body can be detected in the captured image (Step S401). A known technique may be used to detect a body in the captured image. For example, body detection may be performed using the reliability of feature points of the skeleton of the body included in the captured image, which is calculated using a known technique. The detection of the body may be performed on the basis of information obtained as a result of inputting a captured image to a body detection model generated by machine learning. For example, the body detection model may be a model generated by performing, on a large number of captured images, machine learning processing of the input/output relationship, in which the input information is a captured image that includes a body in a region, and the output information is the region of the body, feature points, and reliability values thereof. When the body detection unit 33 can detect the body in the captured image, the body detection unit 33 records coordinate information (body image information) of the four corners of the rectangular body image m2 including the detected body region in the memory in association with the captured image ID (Step S402). The face detection unit 21 determines whether a face can be detected in the captured image (Step S403). The image processing device 1 repeats the processing of steps S401 and S403 until the face detection unit 21 can detect a face in the captured image. With this processing, in a situation where a person in the photographed image approaches the camera 2 from a distance, one or more body images are recorded in the memory until a face can be detected.

Then, upon determining that a face can be detected in the captured image, the face detection unit 21 outputs the captured image ID indicating the captured image to the body detection unit 22. In addition, the face detection unit 21 records coordinate information (face image information) of the four corners of the rectangular face image m1 including the detected face region in the memory in association with the captured image ID. Upon being able to detect a body in the captured image, the face detection unit 21 outputs the captured image ID indicating the captured image to the correspondence relationship identification unit 23.

Upon acquiring the captured image ID from the face detection unit 21, the correspondence relationship identification unit 23 assigns a person temporary ID in association with the face image information and body image information recorded in the memory in association with that captured image ID, and records it in memory to identify the correspondence relationship (Step S404). As a result, the captured image ID, the temporary person ID, the face image information (coordinate information), and the body image information (coordinate information) are recorded in the memory in association with each other, and the face region and the body region in the captured image of the person M are recorded correspondingly. The correspondence relationship identification unit 23 further records the face image m1 identified from the face image information in the captured image in the memory in association with the captured image ID and the temporary person ID. Also, the correspondence relationship identification unit 23 further records the body image m2 identified from the body image information in the captured image in the memory in association with the captured image ID and the temporary person ID.

When identifying the abovementioned correspondence relationship between the face image information and the body image information, the correspondence relationship identification unit 23 may determine the correspondence relationship on the basis of the coordinate information of the face image information and the body image information. For example, based on the distance between the lower left and lower right coordinates of the face image information and the upper left and upper right coordinates of the body image information, the correspondence relationship identification unit 23 may determine whether each of the left and right coordinates is within a predetermined distance, and determine that there is a correspondence relationship between the face image information and the body image information (image information of the same person) if equal to or less than the predetermined distance.

Alternatively, the correspondence relationship identification unit 23 may input the captured image in which the face is detected by the face detection unit 21 and the body is detected by the body detection unit 22 to a correspondence relationship identification model, and on the basis of the result output by the correspondence relationship identification model, may obtain a result that the region of the face and the region of the body are regions of the same person, and identify the relationship between the region of the face and the region of the body based on the result. In this case, the correspondence relationship identifying unit 23 may acquire the face image information (coordinates) indicating the region of the face and the body image information (coordinates) indicating the region of the body output by the correspondence relationship identification model, and replace image information that is recorded in the memory in association with the captured image ID or temporary person ID with them. For example, the correspondence relationship identification model may be a model that is generated by performing, for a large number of captured images, machine learning of an input/output relationship in which a captured image including a face and a body in a region serves as the input information, and a region of the face and a region of the body of one person in the captured image serve as the output information.

Even when a plurality of persons appear in the captured image, the correspondence relationship identification unit 23 can identify the correspondence relationship between a region of the face and a region of the body of each person. For example, the correspondence relationship identification unit 23 inputs to the correspondence relationship identification model the captured image in which the face detection unit 21 has detected the faces of a plurality of persons and the body detection unit 22 has detected the bodies of a plurality of persons. Then, the body detection unit 22 may acquire the result that the face region and the body region are regions of the same person region for each person based on the result output by the correspondence relationship identification model, and based on that result, identify the relationship between the face region and the body region of each person. The correspondence relationship identification model may be a model that is generated by performing, for a large number of captured images, machine learning of an input/output relationship in which a captured image that includes the faces and bodies of multiple persons in a region serves as the input information, and information in which the correspondence relationship between the face region and body region of each person appearing in the captured image serves as the output information.

Upon recording information such as face image information (coordinates), body image information (coordinates), face image m1, and body image m2 of a person in a captured image in the memory in association with the captured image ID and the temporary person ID, the correspondence relationship identification unit 23 determines that the correspondence relationship can be identified, and outputs the captured image ID and the temporary person ID to the face collation unit 24. The face collation unit 24 acquires the captured image ID of the captured image containing the person whose correspondence relationship has been identified, and the person temporary ID detected for that captured image.

The face collation unit 24 reads the face image recorded in the memory in association with the captured image ID and the temporary person ID. The face collation unit 24 performs face collation processing for that face image using a face collation program (Step S405). The face collation unit 24 inputs a comparison-target face image identified in order from the plurality of face images contained in the database 104. The comparison-target face image may be a face image registered in the database 104 in advance.

The face collation unit 24 calculates the degree of matching between the face image detected by the face detection unit 21 and the face image specified from among the plurality of face images (comparison targets) included in the database 104, for each face image specified in order from among the plurality of face images contained in the database 104. As described above, the face collation program is a program using a model generated by machine learning processing. Thereby, the face collation unit 24 can calculate the degree of matching between the face image detected by the face detection unit 21 and each specified face image from the database 104. The face collation unit 24 determines whether the highest degree of matching between the face image detected by the face detection unit 21 and each specified face image from the database 104 is equal to or greater than a predetermined threshold, and thereby determines whether or not the face collation has succeeded (Step S406). The face collation unit 24 determines that the face collation is successful when the highest degree of matching between the face image detected by the face detection unit 21 and each specified face image from the database 104 is equal to or greater than the predetermined threshold, and determines that the comparison-target face image matches the face image detected by the face detection unit 21.

The face collation unit 24 identifies from the database 104 the person information of the comparison-target face image that is determined to match in the database 104. The person information includes a person ID for identifying the person of the face image. Thereby, the face collation unit 24 can link the captured image ID, the temporary person ID, and the person ID. In other words, it is possible to link the temporary person ID assigned to the person appearing in the captured image indicated by the captured image ID with the person ID of the person indicated by the comparison-target face image that was collated with and matches that person. The face collation unit 24 outputs to the image recording unit 25 a collation result including the captured image ID, the temporary person ID, and the person ID.

The image recording unit 25 reads the body image recorded in the memory in association with the captured image ID, the temporary person ID, and the person ID. The image recording unit 25 determines whether the read body image and the image information of the body region included in that body image satisfy a recording condition (Step S407). This processing is the same as in the first example embodiment.

When the body image or the image information of the body region included in the body image satisfies the recording condition, the image recording unit 25 records the body image in the person table of the database 104 in association with the person ID (Step S408). The image recording unit 25 may read a face image recorded in the memory in association with the captured image ID, temporary person ID and person ID, and record the face image in the person table of the database 104 in association with the person ID. The image recording unit 25 may read a body image and a face image recorded in the memory in association with the captured image ID, temporary person ID and person ID, and record the body image and face image in the person table of the database 104 in association with the person ID. The image recording unit 25 may read a body image and a face image recorded in the memory in association with the captured image ID, temporary person ID and person ID, and the captured image in which the body image and face image appear, and record the body image, face image and captured image in the person table of the database 104 in association with the person ID. The face image and captured image may also be recorded when the predetermined recording condition is satisfied, as with the body image. The image processing device 1 uses the body image and the face image recorded in the person table for the person collation process to be performed later. Since the body image, the face image, and the captured image that satisfy the predetermined recording condition are recorded in this manner, the collation process can be performed with higher accuracy.

According to the fifth example embodiment, even if a face image cannot be detected in a captured image, a body image for recording is first stored in a memory or the like. Then, at the stage when the face image is detected, the image processing device 1 can specify the correspondence relationship between the face image and the body image, and record the body image as information of the identified person based on the face image.

FIG. 14 is a diagram showing a minimum configuration of the image processing device.

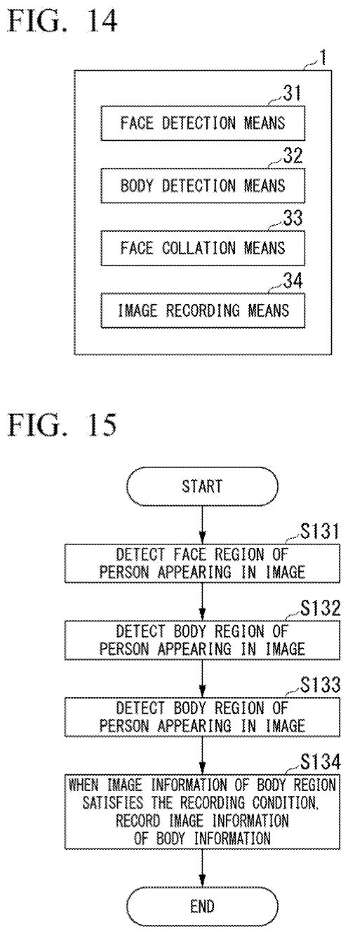

FIG. 15 is a diagram showing the processing flow by an image processing device with a minimum configuration.

The image processing device 1 includes at least a face detection means 41, a body detection means 42, a face collation means 43, and an image recording means 44.

The face detection means 41 detects the face region of the person appearing in the image (Step S131).

The body detection means 42 detects the body region of the person appearing in the image (Step S132).

The face collation means 43 performs face collation processing using the image information of the face region (Step S133).

The image recording means 44 records the image information of the body region of the person identified as a result of the face collation process. At this time, if the image information of the body region satisfies the recording condition, the image recording means 44 records the image information of the body region (Step S134).

Each of the devices described above has an internal computer system. Each process described above is stored in a computer-readable recording medium in the form of a program, and the above processes are performed by reading and executing this program by a computer. Here, the computer-readable recording medium refers to magnetic disks, magneto-optical disks, CD-ROMs, DVD-ROMs, semiconductor memories, and the like. Alternatively, the computer program may be distributed to a computer via a communication line, and the computer receiving the distribution may execute the program.

Further, the program may be one for realizing some of the functions described above. Moreover, the above program may be a so-called differential file (differential program) capable of realizing the above-described functions in combination with a program previously recorded in a computer system.

### DESCRIPTION OF REFERENCE SYMBOLS

1 Image processing device
2 Camera
11 Input unit
12 Recording determination unit
13 Collation unit
14 Tracking unit
21 Face detection unit
22 Body detection unit
23 Correspondence relationship identification unit
24 Face collation unit
Image recording unit
26 Body collation unit
31 Face detection unit
32 Face collation unit
33 Body detection unit
34 Body collation unit
35 Output unit
100 Collation system

What is claimed is:

1. An image processing device comprising:
a memory configured to store instructions; and
a processor configured to execute the instructions to:
detect a face region of a person appearing in an image;
detect a body region of the person appearing in the image;
perform face collation processing using image information of the face region;
identify a correspondence relationship between the image information of the face region and image information of the body region when the image information of the face region and the image information of the body region satisfy a predetermined correspondence relationship; and
record the image information of the body region of the person identified as a result of the face collation processing when the image information of the body region satisfies a recording condition.

2. The image processing device according to claim 1, wherein the recording condition is information indicating that a state of the image is a predetermined state.

3. The image processing device according to claim 1, wherein the recording condition is information indicating that a posture of the person whose body region has been detected is in a predetermined state.

4. The image processing device according to claim 1, wherein the recording condition is information indicating that an attribute or an accessory of the person whose body region has been detected differs from image information of a body region recorded for the person identified as a result of the face collation processing.

5. The image processing device according to claim 1,
wherein the processor is configured to execute the instructions to perform body collation processing using previously recorded image information of a body region of the person identified as the result of the face collation processing and the image information of the body region having the correspondence relationship with the image information of the face region used in the face collation processing, and
wherein the processor is configured to execute the instructions to record the image information of the body region of the person identified as the result of the face collation processing when the image information of the body region having the correspondence relationship with the image information of the face region used in the face collation processing is determined in the body collation processing to be the image information of the body region of the person identified as the result of the face collation processing.

6. The image processing device according to according to claim 1,
wherein the processor is configured to execute the instructions to perform tracking processing using at least one of the image information of the face region or the image information of the body region.

7. An image processing method comprising:
detecting a face region of a person appearing in an image;
detecting a body region of the person appearing in the image;
performing face collation processing using image information of the face region;
identifying a correspondence relationship between the image information of the face region and image information of the body region when the image information of the face region and the image information of the body region satisfy a predetermined correspondence relationship; and
recording the image information of the body region when the image information of the body region of the person identified as a result of the face collation processing satisfies a recording condition.

8. A non-transitory computer-readable medium that stores a program for causing a computer of an image processing device to execute:
detecting a face region of a person appearing in an image;
detecting a body region of the person appearing in the image;
performing face collation processing using image information of the face region;
identifying a correspondence relationship between the image information of the face region and image information of the body region when the image information of the face region and the image information of the body region satisfy a predetermined correspondence relationship; and
recording the image information of the body region when the image information of the body region of the person identified as a result of the face collation processing satisfies a recording condition.
